(19) United States
(12) Patent Application Publication
(10) Pub. No.: US 2023/0311899 A1
(43) Pub. Date: Oct. 5, 2023

(54) DRIVING STATE DETERMINATION APPARATUS, METHOD, AND COMPUTER READABLE MEDIUM

(71) Applicant: NEC Corporation, Minato-ku, Tokyo (JP)

(72) Inventors: Yasunori FUTATSUGI, Tokyo (JP); Yasuhiro MIZUKOSHI, Tokyo (JP)

(73) Assignee: NEC Corporation, Minato-ku, Tokyo (JP)

(21) Appl. No.: 18/024,933

(22) PCT Filed: Sep. 24, 2020
(86) PCT No.: PCT/JP2020/036005

§ 371 Date: Mar. 6, 2023

(51) Int. Cl. B60W 40/08; G06V 20/59; G06V 40/10; G06V 40/16

(52) U.S. Cl. CPC B60W 40/08; G06V 20/597; G06V 40/103; G06V 40/165; B60W 2040/0818; B60W 2420/42; B60W 2540/223; B60W 2540/229

(57) ABSTRACT

A position detection unit detects positions of right and left shoulders of a driver, and positions of at least two body parts of the driver from a driver image obtained by capturing an image of the driver. A shoulder width calculation unit calculate a width of shoulders of the driver based on the detected positions of the right and left shoulders. A threshold determination unit determines at least one determination threshold based on the calculated width of shoulders. A determination unit determines a driving state of the driver by using the positions of the at least two detected body parts detected by the position detection unit and the at least one determination threshold determined by the threshold determination unit.

### TECHNICAL FIELD

The present disclosure relates to a driving state determination apparatus, a method, and a computer readable medium.

### BACKGROUND ART

As related art, Patent Literature 1 discloses a driving state monitoring apparatus that detects a state of a driver based on a driver image (i.e., an image of the driver). The driving state monitoring apparatus disclosed in Patent Literature 1 detects an orientation of the driver's face (i.e., a direction in which the driver's face faces), and determines whether or not the driver is concentrating his/her attention on driving based on the orientation of the driver's face. The orientation of the face (the posture of the head) is expressed by a horizontal inclination angle (a yaw angle) and a vertical inclination angle (a pitch angle) of the head in a normalized spherical coordinate system. The driving state monitoring apparatus detects (i.e., determines) that the driver is in a distracted state when the horizontal inclination angle and/or the vertical inclination angle are greater than an angle threshold, and the duration of that state is longer than a time threshold.

In addition to the above-described feature, the monitoring state apparatus detects a hand of the driver, a target object, and the like. The driving state monitoring apparatus determines that the driver is eating or drinking when the type of the target object is a container or food and the detection box of the target object and the detection box of the mouth of the driver overlap each other. In the case where the type of the target object is an electronic apparatus, the driving state monitoring apparatus determines that the driver is using the electronic apparatus when the detection box of the hand and the detection box of the target object overlap each other and the minimum distance between the detection box of the target object and the detection box of the mouth or the eye(s) is shorter than a predetermined distance.

As another related art, Patent Literature 2 discloses another type of driving state monitoring apparatus. The driving state monitoring apparatus disclosed in Patent Literature 2 detects face information indicating the state of the driver's face from a face image of the driver (i.e., an image of the driver's face). The driving state monitoring apparatus creates a frequency distribution of face information over a preset (i.e., predetermined) time period when a change occurs in the driver's face. The driving state monitoring apparatus calculates the mode value of the face information from the frequency distribution of the face information and calculates a reference value indicating a regular state of the driver based on the mode value of the face information. The driving state monitoring apparatus determines the driving state of the driver by comparing the face information of the driver with the calculated reference value. The driving state monitoring apparatus sets, for each driver, a normal visibility range for the driver based on the calculated reference value, and determines a looking-aside state of the driver (i.e., a state in which the driving is looking aside) by comparing the current visibility range with the normal visibility range.

### CITATION LIST

### Patent Literature

Patent Literature 1: Published Japanese Translation of PCT International Publication for Patent Application, No. 2019-536673

Patent Literature 2: International Patent Publication No. WO2018/150485

### SUMMARY OF INVENTION

### Technical Problem

In Patent Literature 1, it is determined that the driver is in a distracted state when the horizontal and vertical inclination angles of the face are greater than the angle threshold(s). However, since the angle of view and the focal length could vary depending on the camera and the vehicle, the size and orientation of the driver in the driver image could change depending on the camera and the vehicle. In Patent Literature 1, a predetermined fixed value is used for the angle threshold and the like, and it is difficult to accurately determine whether or not the driver is in the distracted state by using such a fixed threshold.

In Patent Literature 2, a reference value is set based on the mode value of the face information, and the normal visibility range is set based on the reference value. In Patent Literature 2, it is presumed that the upper and lower limits of the normal visibility range are set to values that differ from the reference value by certain values. Therefore, in Patent Literature 2, in consideration of the fact that the sizes of drivers shown in their driver images may differ from one another, there is a possibility that the looking-aside state of a driver cannot be accurately determined.

In view of the above-described circumstances, an object of the present disclosure is to provide a driving state determination apparatus, a method, and a computer readable medium capable of accurately determining the driving state of a driver even in the case where the sizes of drivers shown in their driver images are not equal to each other.

### Solution to Problem

To achieve the above-described object, in a first aspect, the present disclosure provides a driving state determination apparatus. The driving state determination apparatus includes: position detection means for detecting positions of right and left shoulders of a driver, and positions of at least two body parts of the driver from a driver image obtained by capturing an image of the driver; shoulder width calculation means for calculating a width of shoulders of the driver based on the detected positions of the right and left shoulders; threshold determination means for determining at least one determination threshold based on the calculated width of shoulders; and determination means for determining a driving state of the driver by using the positions of the at least two detected body parts and the at least one determination threshold.

In a second aspect, the present disclosure provides a driving state determination method. The driving state determination method includes; detecting positions of right and left shoulders of a driver, and positions of at least two body parts of the driver from a driver image obtained by capturing an image of the driver; calculating a width of shoulders of the driver based on the detected positions of the right and left shoulders; determining at least one determination threshold based on the calculated width of shoulders; and determining a driving state of the driver by using the positions of the at least two detected body parts and the at least one determination threshold.

In a third aspect, the present disclosure provides a computer readable medium. The computer readable media stores a program for causing a processor to perform processes including: detecting positions of right and left shoulders of a driver, and positions of at least two body parts of the driver from a driver image obtained by capturing an image of the driver; calculating a width of shoulders of the driver based on the detected positions of the right and left shoulders; determining at least one determination threshold based on the calculated width of shoulders; and determining a driving state of the driver by using the positions of the at least two detected body parts and the at least one determination threshold.

### Advantageous Effects of Invention

A driving state determination apparatus, a method, and a computer readable medium according to this disclosure can accurately determine the driving state of a driver even in the case where the sizes of drivers shown in their driver images are not equal to each other.

### BRIEF DESCRIPTION OF DRAWINGS

FIG. 1 is a block diagram showing a schematic configuration of a driving state determination apparatus according to the present disclosure;

FIG. 2 is a block diagram showing a driving state determination apparatus according to a first example embodiment of the present disclosure;

FIG. 3 schematic shows body parts detected from a driver image;

FIG. 4 is a flowchart showing an operating procedure performed by a driving state determination apparatus;

FIG. 5 is a block diagram showing a driving state determination apparatus according to a second example embodiment of the present disclosure;

FIG. 6 schematically shows a head and hands detected from a driver image;

FIG. 7 is a flowchart showing an operating procedure for determining that a driver is driving a vehicle while doing another thing; and

FIG. 8 is a block diagram showing a hardware configuration of an electronic apparatus.

### EXAMPLE EMBODIMENT

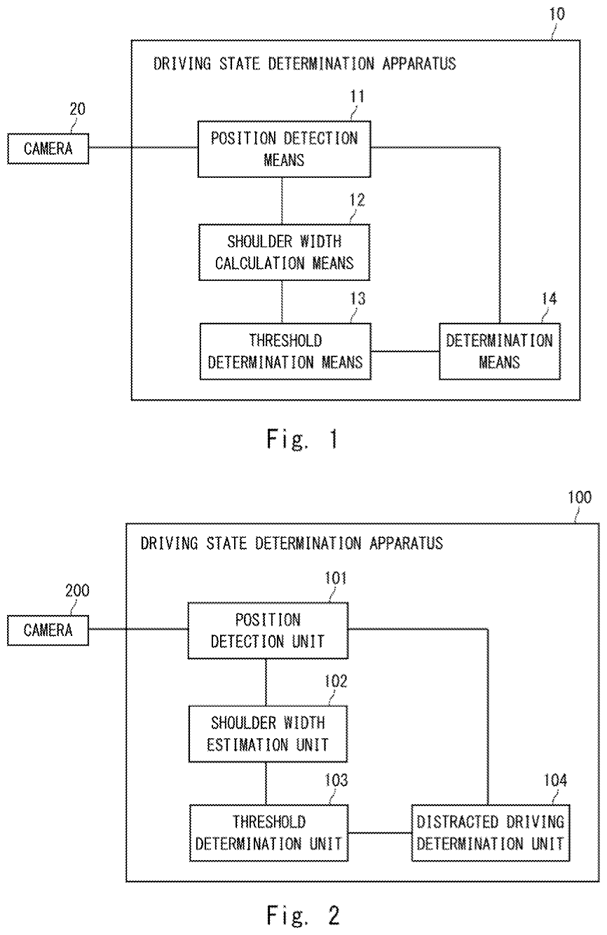

An overview of the present disclosure will be described prior to describing an example embodiment according to the present disclosure. FIG. 1 shows a schematic configuration of a driving state determination apparatus according to the present disclosure. The driving state determination apparatus 10 includes position detection means 11, shoulder width calculation means 12, threshold determination means 13, and determination means 14. The position detection means 11 acquires an image from a camera 20. The camera 20 takes (e.g., captures) the driver of the vehicle and outputs a driver image (i.e., the image of the driver taken by the camera 20) to the position detection means 11. The position detection means 11 detects the positions of the right and left shoulders of the driver from the acquired driver image. Further, the position detection means 11 detects the positions of at least two body parts of the driver.

The shoulder width calculation means 12 calculates the shoulder width (the width of shoulders) of the driver based on the positions of the right and left shoulders detected by the position detection means 11. The threshold determination means 13 determines at least one determination threshold based on the shoulder width calculated by the shoulder width calculation means 12. The determination means 14 determines the driving state of the driver by using the positions of at least two body parts detected by the position detection means 11 and at least one determination threshold determined by the threshold determination means 13.

In the present disclosure, the threshold determination means 13 determines the determination threshold used in the determination means 14 based on the shoulder width of the driver. It is considered that the shoulder width indicates the size of the driver in the driver image. The determination means 14 can determine the driving state by using the determination threshold that is properly set both when the driver is large or when the driver is small. In this way, the driving state determination apparatus 10 according to the present disclosure can accurately determine the driving state of the driver irrespective of the angle of view of the camera 20 and the size of the driver in the image.

An example embodiment according to the present disclosure will be described hereinafter in detail. FIG. 2 shows a driving state determination apparatus according to a first example embodiment of the present disclosure. The driving state determination apparatus 100 includes a position detection unit 101, a shoulder width estimation unit 102, a threshold determination unit 103, and a distracted driving determination unit 104.

The driving state determination apparatus 100 is configured, for example, as an electronic apparatus that can be retrofitted to a vehicle. The driving state determination apparatus 100 may be incorporated into (i.e., built into) an electronic apparatus that is installed in a vehicle. For example, the driving state determination apparatus 100 is incorporated into (e.g., built into) a dashboard camera including a camera that takes (e.g., captures) a video image of an area outside the vehicle and a controller that records the taken video image in a recording medium. The driving state determination apparatus 100 corresponds to the driving state determination apparatus 10 shown in FIG. 1.

The driving state determination apparatus 100 acquires a video image including a driver image from a camera 200. The camera 200 captures, for example, images of the driver's seat (the driver) from a position, in the width direction of the vehicle, shifted from the center of the driver's seat to the passenger's seat side, and located on the front side of the position of the driver's face. As an example, the camera 200 is disposed at or near the base of the rearview mirror of the windshield, and is configured to capture images of the driver sitting in the driver's seat from the center of the vehicle in an oblique direction. For example, in the case where the vehicle is a right-hand-drive vehicle, the camera 200 captures images of the driver from a position in front of and to the left of the driver.

The camera 200 may capture not only the video image of the area inside the vehicle but also a video image of an area outside the vehicle. For example, the camera 200 may be a 360-degree camera that captures a video image(s) of areas ahead of, behind, to the right of, to the left of, and inside the vehicle. The camera 200 outputs the taken video image(s) to the driving state determination apparatus 100 as a moving image(s). The camera 200 may be a part of the driving state determination apparatus 100. The camera 200 corresponds to the camera 20 shown in FIG. 1.

The driving state determination apparatus 100 determines the driving state of the driver based on the driver image acquired from the camera 200. The driving state determination apparatus 100 determines, for example, whether or not the driver is in a driving state in which the driver is not concentrating his/her attention on driving. In this example embodiment, the driving state determination apparatus 100 determines a state in which the driver is driving the vehicle while looking aside as a driving state in which the driver is not concentrating his/her attention on driving.

The position detection unit 101 detects the positions of the right and left shoulders of the driver from the driver image acquired from the camera 200. The position detection unit 101 may, for example, estimate the two-dimensional skeletal structure of the driver from the driver image and detect the positions of the right and left shoulders based on the estimated two-dimensional skeletal structure. The position detection unit 101 outputs the detected positions of the right and left shoulders to the shoulder width estimation unit 102.

The position detection unit 101 further detects the positions of at least two body parts of the driver. In this example embodiment, the position detection unit 101 detects the positions of the right eye, left eye, right ear, and left ear of the driver. Any algorithm can be used to detect the positions of the right eye, left eye, right ear, and left ear of the driver. The position detection unit 101 outputs the detected positions of the right eye, left eye, right ear, and left ear to the distracted driving determination unit 104. The position detection unit 101 may detect the position(s) of any object(s) other than the body parts of the driver. The position detection unit 101 corresponds to the position detection means 11 shown in FIG. 1.

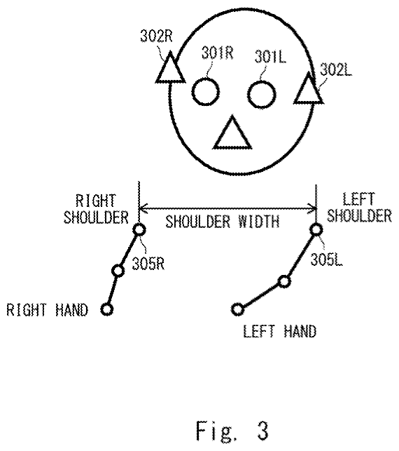

FIG. 3 schematically shows body parts detected from the driver image. The position detection unit 101 estimates the skeletal structure of the driver and detects the position of the right shoulder 305R and left shoulder 305L of the driver. Further, the position detection unit 101 detects the positions of the right eye 301R, left eye 301L, right ear 302R and left ear 302L.

The shoulder width estimation unit 102 calculates the shoulder width of the driver based on the positions of the right and left shoulders detected in the position detection unit 101. The shoulder width estimation unit 102 calculates, for example, a distance between the detected right and left shoulders 305R and 305L shown in FIG. 3 as the shoulder breadth. The shoulder width estimation unit 102 corresponds to the shoulder width calculation means 12 shown in FIG. 1.

The threshold determination unit 103 determines at least one determination threshold used to determine the driving state based on the shoulder width calculated by the shoulder width estimation unit 102. The determination threshold indicates, for example, a threshold for a distance between certain body parts of a human being.

In this example embodiment, the threshold determination unit 103 determines first and second determination thresholds used to determine a state in which the driver looking aside to the right, and third and fourth determination thresholds used to determine a state in which the driver looking aside to the left. Each of the first and third determination thresholds indicates the threshold for the distance between the right and left eyes. The second determination threshold indicates a threshold for the distance between the left eye and the left ear. The fourth determination threshold indicates a threshold for the distance between the right eye and the right ear.

For example, the threshold determination unit 103 stores a pair of a reference shoulder width and a reference determination threshold for each of the determination thresholds. The threshold determination unit 103 compares, for example, a shoulder width calculated by the shoulder width estimation unit 102 with the reference shoulder breadth, and determines the determination threshold based on the result of the comparison. For example, the threshold determination unit 103 calculates a difference or a ratio between the shoulder width calculated by the shoulder width estimation unit 102 and the reference shoulder breadth. The threshold determination unit 103 determines the determination threshold by increasing or decreasing the reference determination threshold according to the calculated difference or ratio. When the shoulder width calculated by the shoulder width estimation unit 102 is shorter than the reference shoulder breadth, the threshold determination unit 103 determines (i.e., sets) the determination threshold to a value smaller than the reference determination threshold. When the shoulder width calculated by the shoulder width estimation unit 102 is longer than the reference shoulder breadth, the threshold determination unit 103 determines (i.e., sets) the determination threshold to a value larger than the reference determination threshold. The threshold determination unit 103 corresponds to the threshold determination means 13 shown in FIG. 1.

The distracted driving determination unit 104 calculates a distance between specific body parts based on the positions of the right eye, left eye, right ear, and left ear detected by the position detection unit 101. In this example embodiment, the distracted driving determination unit 104 calculates the distance between the right and left eyes in the driver image based on the positions of the right and left eyes. Further, the distracted driving determination unit 104 calculates the distance between the left eye and the left ear in the driver image based on the position of the left eye and the left ear. The distracted driving determination unit 104 calculates the distance between the right eye and the right ear in the driver image based on the position of the right eye and the right ear.

The distracted driving determination unit 104 compares the above-described calculated distance between the right and left eyes with the first determination threshold determined by the threshold determination unit 103. Further, the distracted driving determination unit 104 compares the above-described calculated distance between the left eye and the left ear with the second determination threshold. The distracted driving determination unit 104 determines whether or not the driver is driving the vehicle while looking aside based on the result of the comparison between the distance between the right and left eyes and the first determination threshold, and the result of the comparison between the distance between the left eye and the left ear and the second determination threshold. In the case where the vehicle is a right-hand-drive vehicle, the distracted driving determination unit 104 determines that the driver is looking aside to the right when the distance between the right and left eyes is equal to or smaller than the first determination threshold, and the distance between the left eye and left ear is equal to or larger than the second determination threshold.

Further, the distracted driving determination unit 104 compares the above-described calculated distance between the right and left eyes with the third determination threshold determined by the threshold determination unit 103. The distracted driving determination unit 104 compares the above-described calculated distance between the right eye and the right ear with the fourth determination threshold. The distracted driving determination unit 104 determines whether or not the driver is driving the vehicle while looking aside based on the result of the comparison between the distance between the right and left eyes and the third determination threshold, and the result of the comparison between the distance between the right eye and the right ear and the fourth determination threshold. In the case where the vehicle is a right-hand-drive vehicle, the distracted driving determination unit 104 determines that the driver is looking aside to the left when the distance between the right and left eyes is larger than the third determination threshold, and the distance between the right eye and the right ear is smaller than the fourth determination threshold. The distracted driving determination unit 104 corresponds to the determination means 14 shown in FIG. 1.

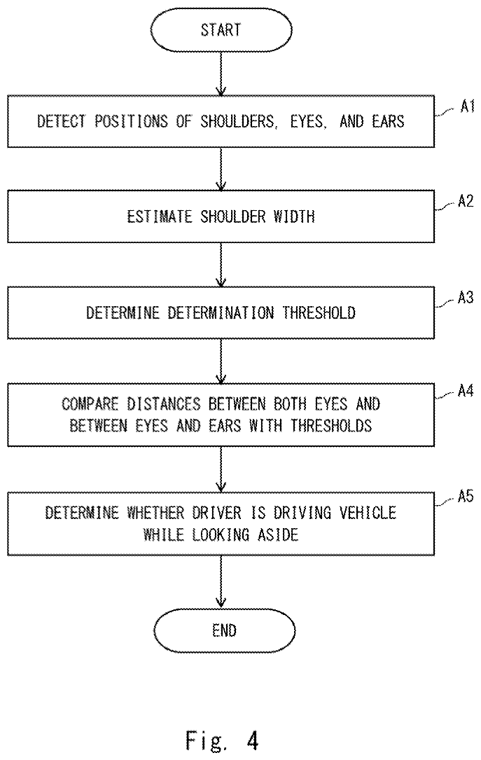

Next, an operating procedure will be described. FIG. 4 shows an operating procedure (a driving state determination method) performed by the driving state determination apparatus 100. The position detection unit 101 acquires a driver image from the camera 200. The position detection unit 101 detects the positions of both shoulders, both eyes, and both ears of the driver from the driver image (Step A1). The shoulder width estimation unit 102 estimates the shoulder width (i.e., the width of the shoulders) of the driver from the positions of both shoulders of the driver detected in the step A1 (Step A2).

The threshold determination unit 103 determines determination thresholds based on the shoulder width estimated in the step A2 (Step A3). In the step A3, the threshold determination unit 103 determines the first and third determination thresholds for the distance between both eyes. Further, the threshold determination unit 103 determines the second determination threshold for the distance between the left ear and the left eye, and the fourth determination threshold for the distance between the right eye and the right ear.

The distracted driving determination unit 104 calculates the distance between both eyes, the distance between the left eye and the left ear, and the distance between the right eye and the right ear based on the positions of both eyes and both ears detected in the step A1. The distracted driving determination unit 104 compares the calculated the distance between both eyes, the distance between the left eye and the left ear, and the distance between the right eye and the right ear with their respective determination thresholds (Step A4). In the step A4, the distracted driving determination unit 104 compares the distance between both eyes and the first determination threshold, and compares the distance between the left eye and the left ear with the second determination threshold. Further, the distracted driving determination unit 104 compares the distance between both eyes and the third determination threshold, and compares the distance between the right eye and the right ear with the fourth determination threshold.

The distracted driving determination unit 104 determines whether or not the driver is driving the vehicle while looking aside based on the results of the comparisons in the step A4 (Step A5). In the step A5, for example, when the distance between both eyes is equal to or smaller than the first determination threshold, and the distance between the left eye and the left ear is equal to or larger than the second determination threshold, the distracted driving determination unit 104 determines that the driver is driving the vehicle while looking aside to the right. When the distance between both eyes is equal to or larger than the third determination threshold and the distance between the right eye and the right ear is equal to or smaller than the fourth determination threshold, the distracted driving determination unit 104 determines that the driver is driving the vehicle while looking aside to the left.

In this example embodiment, the position detection unit 101 detects the positions of the right and left shoulders of the driver, and the shoulder width estimation unit 102 calculates the shoulder width of the driver based on the detected positions of the right and left shoulders. The threshold determination unit 103 determines the determination threshold used in the distracted driving determination unit 104 based on the calculated shoulder breadth. In this example embodiment, the distracted driving determination unit 104 determines whether or not the driver is driving the vehicle while looking aside by using, instead of fixed thresholds, determination thresholds that have been determined according to the shoulder width by the threshold determination unit 103. Therefore, the driving state determination apparatus 100 can determine whether or not the driver is driving the vehicle while looking aside irrespective of the size of the driver in the driver image. As described above, in this example embodiment, since the determination thresholds are determined according to the shoulder breadth, the driving state determination apparatus 100 can accurately detect distracted driving (i.e., a state in which the driver is driving the vehicle while looking aside) even when the angle of view and the focal length of the camera 200 change from one driver image to another.

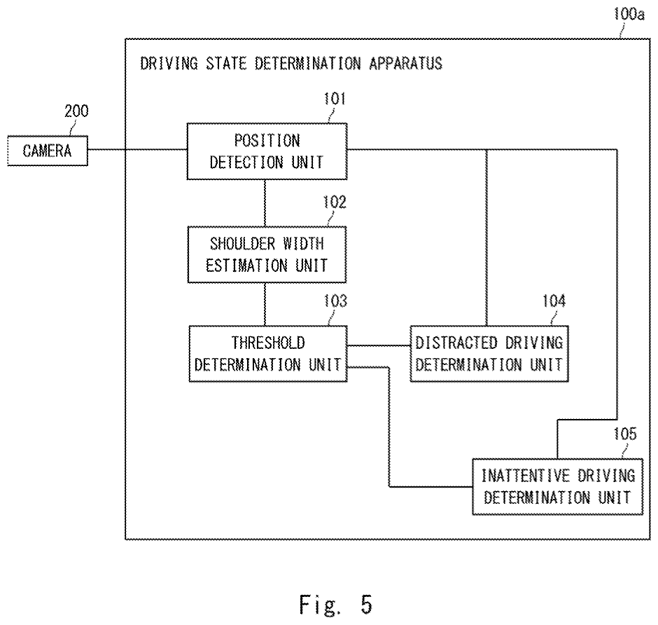

Next, a second example embodiment according to the present disclosure will be described. FIG. 5 shows a driving state determination apparatus according to the second example embodiment of the present disclosure. In this example embodiment, the driving state determination apparatus 100a includes an inattentive driving determination unit 105 in addition to the components of the driving state determination apparatus 100 according to the first example embodiment shown in FIG. 2. In addition to determining whether or not the driver is driving the vehicle while looking aside, the driving state determination apparatus 100a determines whether or not the driver is driving the vehicle while doing another thing. In this example embodiment, the operation performed by the driving state determination apparatus 100a to determine whether or not the driver is driving the vehicle while looking aside may be similar to that described above in the first example embodiment.

In this example embodiment, the state in which the driver is driving the vehicle while doing another thing refers to a state in which the driver is driving the vehicle while performing an action or the like other than the driving of the vehicle. The state in which the driver is driving the vehicle while doing another thing may include at least one of a state in which the driver is driving the vehicle while talking on a phone (or using a phone). Additionally or alternatively, the state in which the driver is driving the vehicle while doing another thing may include at least one of a state in which the driver is driving the vehicle while eating some food, a state in which the driver is driving the vehicle while drinking some drink, and a state in which the driver is driving the vehicle while smoking.

In this example embodiment, the position detection unit 101 detects, in addition to the positions of the right shoulder, left shoulder, right eye, left eye, right ear, and left ear of the driver, the positions of his/her head, right hand, and left hand. The position detection unit 101 outputs the detected positions of the head, right hand, and left hand of the driver to the inattentive driving determination unit 105. The threshold determination unit 103 determines a determination threshold (a fifth determination threshold) used in the inattentive driving determination unit 105 in addition to the determination thresholds used in the distracted driving determination unit 104. The fifth determination threshold indicates a threshold for a distance between the head and hand of the driver. The threshold determination unit 103 outputs the determined fifth determination threshold to the inattentive driving determination unit 105.

The inattentive driving determination unit 105 calculates the distance between the head and hand of the driver. The inattentive driving determination unit 105 uses one of the distance between the head and the right hand and the distance between the head and the left hand that is shorter than the other as the distance between the head and hand of the driver. The inattentive driving determination unit 105 compares the distance between the head and the hand with the fifth determination threshold. When the distance between the head and the hand is equal to or smaller than the fifth determination threshold, the inattentive driving determination unit 105 determines that the driver is driving the vehicle while doing another thing.

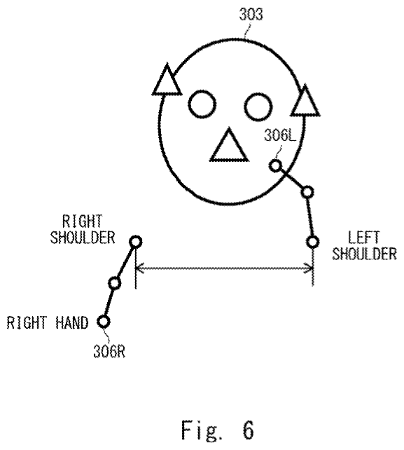

FIG. 6 schematically shows a head and hands detected from a driver image. The position detection unit 101 detects the positions of a head 303, a right hand 306R, and a left hand 306L from the driver image. The inattentive driving determination unit 105 calculates a distance between the head 303 and the right hand 306R, and a distance between the head 303 and the left hand 306L. In the example shown in FIG. 6, the distance between the head 303 and the left hand 306L is shorter than the distance between the head 303 and the right hand 306R. The inattentive driving determination unit 105 compares the distance between the head 303 and the left hand 306L with the fifth determination threshold. In the example shown in FIG. 6, since the head 303 and the left hand 306L overlap each other, the inattentive driving determination unit 105 determines that the driver is driving the vehicle while doing another thing.

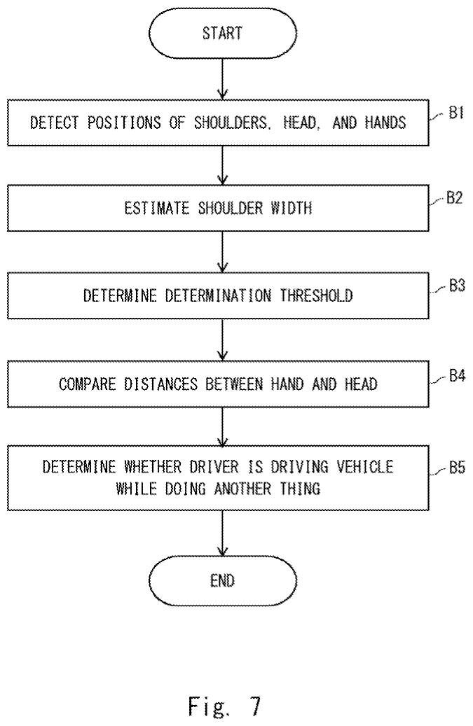

Next, an operating procedure will be described. FIG. 7 shows an operating procedure performed by the driving state determination apparatus 100a when it determines whether the driver is driving the vehicle while doing another thing. The operating procedure that is performed by the driving state determination apparatus 100a to determine a state in which the driver is driving the vehicle while looking aside is similar to that shown in FIG. 4.

The position detection unit 101 detects the positions of both shoulders, head, and both hands of the driver from the driver image acquired from the camera 200 (Step B1). The shoulder width estimation unit 102 estimates the shoulder width of the driver from the positions of both shoulders of the driver detected in the step B1 (Step B2). The threshold determination unit 103 determines a determination threshold for the distance between the head and the hand based on the shoulder width estimated in the step B2 (Step B3).

The inattentive driving determination unit 105 calculates the distance between the head and the hand based on the positions of the head and both hands detected in the step B1. The inattentive driving determination unit 105 compares the calculated distance between the head and the hand with the determination threshold determined in the step B3 (Step B4). The inattentive driving determination unit 105 determines whether or not the driver is driving the vehicle while doing another thing based on the result of the comparison performed in the step B4 (Step B5). In the step B5, the inattentive driving determination unit 105 determines that, for example, the driver is driving the vehicle while doing another thing when the distance between the head and the hand is equal to or smaller than the determination threshold.

In this example embodiment, the threshold determination unit 103 determines the determination threshold used in the inattentive driving determination unit 105 based on the shoulder width of the driver. The inattentive driving determination unit 105 determines whether or not the driver is driving the vehicle while doing another thing by using the determination threshold determined according to the shoulder breadth. In this example embodiment, the determination threshold is also determined according to the shoulder width of the driver. Therefore, the driving state determination apparatus 100a can determine whether or not the driver is driving the vehicle while doing another thing irrespective of the size of the driver in the driver image, and can accurately detect whether the driver is driving the vehicle while doing another thing even when the angle of view and the focal length of the camera 200 change from one driver image to another.

Note that although the example in which the driving state determination apparatus 100a includes the distracted driving determination unit 104 and the inattentive driving determination unit 105 has been described in the above-described second example embodiment, the present disclosure is not limited to this example. The driving state determination apparatus 100a may determine at least one driving state of a driver and may not include the distracted driving determination unit 104. Alternatively, the driving state determination apparatus 100a may include a determination unit that determines a driving state other than the state in which the driver is driving the vehicle while looking aside or while doing another thing.

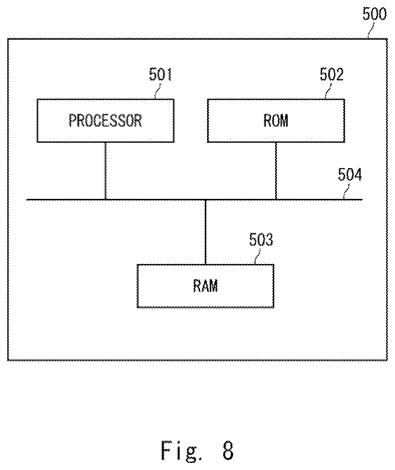

In the present disclosure, the driving state determination apparatus 100 may be constructed as an electronic apparatus(es) including a processor(s). FIG. 8 shows a hardware configuration of an electronic apparatus that can be used for the driving state determination apparatus 100. The electronic apparatus 500 includes a processor 501, a ROM (read only memory) 502, and a RAM (random access memory) 503. In the electronic apparatus 500, the processor 501, the ROM 502, and the RAM 503 are connected to each other through a bus 504. The electronic apparatus 500 may include other circuits such as peripheral circuits and interface circuits though they are not shown in the drawing.

The ROM 502 is a nonvolatile storage device. For the ROM 502, a semiconductor storage device such as a flash memory having a relatively small capacity is used. The ROM 502 stores a program(s) to be executed by the processor 501.

The aforementioned program can be stored and provided to the electronic apparatus 500 by using any type of non-transitory computer readable media. Non-transitory computer readable media include any type of tangible storage media. Examples of non-transitory computer readable media include magnetic storage media such as floppy disks, magnetic tapes, and hard disk drives, optical magnetic storage media such as magneto-optical disks, optical disk media such as CD (Compact Disc) and DVD (Digital Versatile Disk), and semiconductor memories such as mask ROM, PROM (Programmable ROM), EPROM (Erasable PROM), flash ROM, and RAM. Further, the program may be provided to the electronic apparatus by using any type of transitory computer readable media. Examples of transitory computer readable media include electric signals, optical signals, and electromagnetic waves. Transitory computer readable media can provide the program to the electronic apparatus via a wired communication line such as electric wires and optical fibers or a radio communication line.

The RAM 503 is a volatile storage device. As the RAM 503, various types of semiconductor memory apparatuses such as a DRAM (Dynamic Random Access Memory) or an SRAM (Static Random Access Memory) can be used. The RAM 540 can be used as an internal buffer for temporarily storing data or the like.

The processor 501 expands (i.e., loads) a program stored in the ROM 502 in the RAM 503, and executes the expanded (i.e., loaded) program. As the processor 501 executes the program, the function of each unit of the driving state determination apparatus 100 can be implemented.

Although example embodiments according to the present disclosure have been described above in detail, the present disclosure is not limited to the above-described example embodiments, and the present disclosure also includes those that are obtained by making changes or modifications to the above-described example embodiments without departing from the scope of the present disclosure.

The whole or part of the example embodiments disclosed above can be described as, but not limited to, the following Supplementary notes.

### [Supplementary Note 1]

A driving state determination apparatus comprising:
position detection means for detecting positions of right and left shoulders of a driver, and positions of at least two body parts of the driver from a driver image obtained by capturing an image of the driver;
shoulder width calculation means for calculating a width of shoulders of the driver based on the detected positions of the right and left shoulders;
threshold determination means for determining at least one determination threshold based on the calculated width of shoulders; and
determination means for determining a driving state of the driver by using the positions of the at least two detected body parts and the at least one determination threshold.

### [Supplementary Note 2]

The driving state determination apparatus described in Supplementary note 1, wherein the position detection means estimates a skeletal structure of the driver based on the driver image and detects the positions of the right and left shoulders based on the estimated skeletal structure.

### [Supplementary Note 3]

The driving state determination apparatus described in Supplementary note 1 or 2, wherein the threshold determination means stores a pair of a reference shoulder width and a reference determination threshold, and determines the determination threshold by increasing or decreasing the reference determination threshold according to a difference or a ratio between the calculated shoulder width and the reference shoulder breadth.

### [Supplementary Note 4]

The driving state determination apparatus described in any one of Supplementary notes 1 to 3, wherein the determination means determines a driving state in which the driver is not concentrating his/her attention on driving as the driving state of the driver.

### [Supplementary Note 5]

The driving state determination apparatus described in any one of Supplementary notes 1 to 4, wherein the determination threshold is a threshold for a distance between specific body parts of a human being.

### [Supplementary Note 6]

The driving state determination apparatus described in Supplementary note 5, wherein
the at least two body parts include a head of the driver and a hand of the driver, and
the threshold determination means determines a threshold for a distance between the head and the hand as the determination threshold, and
the determination means determines that the driver is driving the vehicle while performing an action other than the driving when the distance between the head and the hand is equal to or smaller than the determination threshold.

### [Supplementary Note 7]

The driving state determination apparatus described in Supplementary note 5 or 6, wherein
the at least two body parts include a right eye, a left eye, and a left ear of the driver,
the threshold determination means determines a first determination threshold indicating a threshold for a distance between the right and left eyes, and a second determination threshold indicating a threshold for a distance between the left eye and the left ear, and
the determination means compares the distance between the right and left eyes with the first determination threshold, compares the distance between the left eye and the left ear with the second determination threshold, and determines whether or not the driver is driving the vehicle while looking aside based on a result of the comparison between the distance between the right and left eyes and the first determination threshold, and a result of the comparison between the distance between the left eye and the left ear and the second determination threshold.

### [Supplementary Note 8]

The driving state determination apparatus described in any one of Supplementary notes 5 to 7, wherein
the at least two body parts include a right eye, a left eye, and a right ear of the driver,
the threshold determination means determines a third determination threshold indicating a threshold for a distance between the right and left eyes, and a fourth determination threshold indicating a threshold for a distance between the right eye and the right ear, and
the determination means compares the distance between the right and left eyes with the third determination threshold, compares the distance between the right eye and the right ear with the fourth determination threshold, and determines whether or not the driver is driving the vehicle while looking aside based on a result of the comparison between the distance between the right and left eyes and the third determination threshold, and a result of the comparison between the distance between the right eye and the right ear and the fourth determination threshold.

### [Supplementary Note 9]

The driving state determination apparatus described in any one of Supplementary notes 1 to 8, wherein the driver image is an image that is obtained by capturing an image of a driver's seat from a position, in a width direction of the vehicle, shifted from a center of the driver's seat to a passenger's seat side, and located on a front side of a position of a driver's face.

### [Supplementary Note 10]

The driving state determination method comprising;
detecting positions of right and left shoulders of a driver, and positions of at least two body parts of the driver from a driver image obtained by capturing an image of the driver;
calculating a width of shoulders of the driver based on the detected positions of the right and left shoulders;
determining at least one determination threshold based on the calculated width of shoulders; and
determining a driving state of the driver by using the positions of the at least two detected body parts and the at least one determination threshold.

### [Supplementary Note 11]

A non-transitory computer readable medium storing a program for causing a processor to perform processes including:
detecting positions of right and left shoulders of a driver, and positions of at least two body parts of the driver from a driver image obtained by capturing an image of the driver;
calculating a width of shoulders of the driver based on the detected positions of the right and left shoulders;
determining at least one determination threshold based on the calculated width of shoulders; and
determining a driving state of the driver by using the positions of the at least two detected body parts and the at least one determination threshold.

### REFERENCE SIGNS LIST

10 DRIVING STATE DETERMINATION APPARATUS
11 POSITION DETECTION MEANS
12 SHOULDER WIDTH CALCULATION MEANS
13 THRESHOLD DETERMINATION MEANS
14 DETERMINATION MEANS
20 CAMERA
100 DRIVING STATE DETERMINATION APPARATUS
101 POSITION DETECTION UNIT
102 SHOULDER-WIDTH ESTIMATION UNIT
103 THRESHOLD DETERMINATION UNIT
104 DISTRACTED DRIVING DETERMINATION UNIT
105 DISTRACTED DRIVING DETERMINATION UNIT
200 CAMERA

What is claimed is:

1. A driving state determination apparatus comprising:
a memory storing instructions; and
a processor configured to execute the instructions to:
detect positions of right and left shoulders of a driver, and positions of at least two body parts of the driver from a driver image obtained by capturing an image of the driver;
calculate a width of shoulders of the driver based on the detected positions of the right and left shoulders;
determine at least one determination threshold based on the calculated width of shoulders; and
determine a driving state of the driver by using the positions of the at least two detected body parts and the at least one determination threshold.

2. The driving state determination apparatus according to claim 1, wherein the processor is configured to execute the instructions to estimate a skeletal structure of the driver based on the driver image and detect the positions of the right and left shoulders based on the estimated skeletal structure.

3. The driving state determination apparatus according to claim 1, wherein the processor is configured to execute the instructions to store a pair of a reference shoulder width and a reference determination threshold, and determine the determination threshold by increasing or decreasing the reference determination threshold according to a difference or a ratio between the calculated shoulder width and the reference shoulder breadth.

4. The driving state determination apparatus according to claim 1, wherein the processor is configured to execute the instructions to determine a driving state in which the driver is not concentrating his/her attention on driving as the driving state of the driver.

5. The driving state determination apparatus according to claim 1, wherein the determination threshold is a threshold for a distance between specific body parts of a human being.

6. The driving state determination apparatus according to claim 5, wherein
the at least two body parts include a head of the driver and a hand of the driver, and
the processor is configured to execute the instructions to:
determine a threshold for a distance between the head and the hand as the determination threshold, and
determine that the driver is driving the vehicle while performing an action other than the driving when the distance between the head and the hand is equal to or smaller than the determination threshold.

7. The driving state determination apparatus according to claim 5, wherein
the at least two body parts include a right eye, a left eye, and a left ear of the driver,
the processor is configured to execute the instructions to:
determine a first determination threshold indicating a threshold for a distance between the right and left eyes, and a second determination threshold indicating a threshold for a distance between the left eye and the left ear, and
compare the distance between the right and left eyes with the first determination threshold, compare the distance between the left eye and the left ear with the second determination threshold, and determine whether or not the driver is driving the vehicle while looking aside based on a result of the comparison between the distance between the right and left eyes and the first determination threshold, and a result of the comparison between the distance between the left eye and the left ear and the second determination threshold.

8. The driving state determination apparatus according to claim 5, wherein
the at least two body parts include a right eye, a left eye, and a right ear of the driver,
the processor is configured to execute the instructions to:
determine a third determination threshold indicating a threshold for a distance between the right and left eyes, and a fourth determination threshold indicating a threshold for a distance between the right eye and the right ear, and
compare the distance between the right and left eyes with the third determination threshold, compare the distance between the right eye and the right ear with the fourth determination threshold, and determine whether or not the driver is driving the vehicle while looking aside based on a result of the comparison between the distance between the right and left eyes and the third determination threshold, and a result of the comparison between the distance between the right eye and the right ear and the fourth determination threshold.

9. The driving state determination apparatus according to claim 1, wherein the driver image is an image that is obtained by capturing an image of a driver's seat from a position, in a width direction of the vehicle, shifted from a center of the driver's seat to a passenger's seat side, and located on a front side of a position of a driver's face.

10. The driving state determination method comprising;
detecting positions of right and left shoulders of a driver, and positions of at least two body parts of the driver from a driver image obtained by capturing an image of the driver;
calculating a width of shoulders of the driver based on the detected positions of the right and left shoulders;
determining at least one determination threshold based on the calculated width of shoulders; and
determining a driving state of the driver by using the positions of the at least two detected body parts and the at least one determination threshold.

11. A non-transitory computer readable medium storing a program for causing a processor to perform processes including:
detecting positions of right and left shoulders of a driver, and positions of at least two body parts of the driver from a driver image obtained by capturing an image of the driver;
calculating a width of shoulders of the driver based on the detected positions of the right and left shoulders;
determining at least one determination threshold based on the calculated width of shoulders; and
determining a driving state of the driver by using the positions of the at least two detected body parts and the at least one determination threshold.
